(19) United States
(12) Patent Application Publication
(10) Pub. No.: US 2006/0256560 A1
(43) Pub. Date: Nov. 16, 2006

(54) Electric-discharge lamp lighting apparatus

(76) Inventor: Susumu Okura, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/547,500

(22) PCT Filed: Oct. 22, 2004
(86) PCT No.: PCT/JP04/15725

§ 371 Date: Aug. 31, 2005

(51) Int. Cl. F21V 23/02

(52) U.S. Cl. 362/265; 315/208

(57) ABSTRACT

A discharge lamp lighting device includes a DC/AC conversion section that boosts power supplied from a battery to supply the boosted power to a discharge lamp, an I/F circuit that divides a battery voltage to make a divided voltage and a microprocessor which compares a threshold voltage with the divided voltage obtained by dividing the battery voltage by the I/F circuit to control the DC/AC conversion section, whereby can light and control the discharge lamp with high accuracy.

### BACKGROUND OF THE INVENTION

1. Field of the Invention

The present invention relates to a discharge lamp lighting device for lighting and controlling a discharge lamp such as headlamps of a vehicle.

2. Description of the Related Art

In a discharge lamp lighting device for lighting and controlling a discharge lamp such as headlamps by using a vehicle mounted battery and the like as a power supply, for example, a vehicle mounted battery voltage is boosted and converted to an AC voltageand is applied to the head lamps to light the head lamps. This discharge lamp lighting device has a microprocessor and lights and controls the headlamps by the use of this microprocessor. A reference voltage applied to the microprocessor is developed by the use of the vehicle mounted battery.

By the way, not only the headlamps but also various kinds of other loads are connected to the vehicle mounted battery and hence a battery voltage is varied according to the loads applied to the vehicle mounted battery. The microprocessor monitors the voltage of vehicle mounted battery and when the voltage of vehicle mounted battery is smaller than a threshold voltage previously set, for example, power applied to the headlamps is turned off.

When the voltage of vehicle mounted battery is monitored, the voltage of vehicle mounted battery is divided by the use of an I/F circuit such as voltage dividing resistor and the divided voltage is applied to the microprocessor. An unavoidable error exists between the divided voltage and the reference voltage for microprocessor. For this reason, even if the voltage of vehicle mounted battery is the same, variations in discharge lamp lighting devices cause variations in the voltage recognized by the microprocessor, which results in causing variations in discharge lamp lighting devices at the time of controlling the discharge lamp.

In other words, in the I/F circuit using a voltage dividing resistor, the voltage dividing resistor has an unavoidable error of resistance and hence the divided voltage input to the microprocessor varies from one discharge lamp lighting device to another. On the other hand, the microprocessor evaluates the relationship between the divided voltage and the reference voltage and recognizes the voltage of vehicle mounted battery according to this evaluation result, so that the recognition value of the voltage of vehicle mounted battery varies from one discharge lamp lighting device to another to cause variations at the time of controlling the discharge lamp.

On the other hand, at the time of lighting and controlling a HID (high intensity discharge lamp) on the basis of the abnormal state of power supply, the divided voltage is applied to the microprocessor via an A/D converter and an upper limit and a lower limit are respectively detected by the first and second comparators, and then when the divided voltage applied to the second comparator is lower than the reference voltage of second comparator or when the divided voltage applied to the first comparator is higher than the reference voltage of first comparator, the first or second comparator outputs a signal to bring the first or second switching device to an on state to turn off the HID lamp.

Then, at this time, when a power supply voltage is brought to an abnormal state, in the case of a temporarily abnormal state, the power supply voltage is automatically recovered by the microprocessor and in the case of continuously abnormal state, the power supply is completely stopped by the microprocessor (for example, see patent document 1).

Further, to detect the power supply voltage with high accuracy, the output voltage of A/D converter when a predetermined threshold is applied as a power supply voltage is written to a memory and the threshold written to the memory is adapted to include variations in the resistance of a bleeder circuit to absorb the variations in the resistance. Then, at the time of operation, a CPU compares voltage taken from the A/D converter with the threshold written to the memory and when the CPU detects that the output voltage of A/D converter is lower than the threshold, the CPU sends data to indicate that the power supply voltage is abnormal (for example, see patent document 2).

[Patent document 1] Japanese Unexamined Patent Publication No. 11-283782 (page3, FIGS. 1 and 2)

[Patent document 2] Japanese Unexamined Patent Publication No. 11-304851 (page3, FIGS. 1 and 2)

However, since a conventional discharge lamp lighting device is structured in the manner described above, when the abnormal state of power supply occurs continuously, the microprocessor only stops the power supply completely and does not take variations in the I/F circuit using the voltage dividing resistor into consideration. As a result, the conventional discharge lamp lighting device presents a problem that the device can not monitor the power supply voltage with high accuracy by the microprocessor.

Further, in the conventional discharge lamp lighting device, the output voltage of A/D converter when a predetermined threshold is applied as a power supply voltage, is written to a memory and the threshold written to the memory is adapted to include variations in the resistance of I/F circuit to absorb the variations in the resistance. However, a battery voltage actually recognized by the microprocessor is affected by the reference voltage applied to the microprocessor. As a result, the power supply voltage presents another problem that the device can not recognize the battery voltage with high accuracy and control the discharge lamp with high accuracy.

### SUMMARY OF THE INVENTION

The present invention has been made to solve the above problems. The object of the present invention is to provide a discharge lamp lighting device capable of detecting a battery voltage with high accuracy and controlling a discharge lamp with high accuracy.

A discharge lamp lighting device in accordance with the present invention is characterized by including: a power conversion section that boosts voltage supplied from power supply to apply the boosted voltage to a discharge lamp; voltage dividing means that divides a power supply voltage to make a divided voltage; storage means that stores a divided voltage, which is obtained by applying a predetermined voltage to the voltage dividing means, as a threshold voltage; and control means that compares the threshold voltage with the divided voltage obtained by dividing the power supply voltage by the voltage dividing means to control the power conversion section.

With this arrangement, the discharge lamp lighting device in accordance with the present invention stores a divided voltage, which is obtained by applying a predetermined voltage to the voltage dividing means, as a threshold voltage and compares the threshold voltage with a divided voltage obtained by dividing a power supply voltage by the voltage dividing means to control the power conversion section. Hence, the discharge lamp lighting device can detect a battery voltage with high accuracy and control a discharge lamp with high accuracy.

A discharge lamp lighting device in accordance with the present invention is characterized in that when storage means stores a correction value responsive to a divided voltage obtained by applying a predetermined voltage to voltage dividing means and the predetermined voltage, in place of a threshold voltage, control means controls a power conversion section according to a correction voltage obtained by correcting a divided voltage obtained by dividing a power supply voltage according to the correction value. In addition, a discharge lamp lighting device in accordance with the present invention is characterized in that when the power supply voltage is within a first voltage range, the control means controls the power conversion section by the threshold voltage and when the power supply voltage is within a second voltage range, the control means controls the power conversion section according to a correction voltage obtained according to the correction value.

With this arrangement, the discharge lamp lighting device in accordance with the present invention obtains a correction voltage by correcting a divided voltage obtained by dividing a power supply voltage according to the correction value and controls the power conversion section according to this correction voltage, so that the discharge lamp lighting device can detect a battery voltage with high accuracy and control a discharge lamp with high accuracy. Further, when the power supply voltage is within the first voltage range, the discharge lamp lighting device controls the power conversion section by the threshold voltage and when the power supply voltage is within the second voltage range, the discharge lamp lighting device controls the power conversion section according to the correction voltage obtained according to the correction value, so that the discharge lamp lighting device can control the discharge lamp in consideration of an operating voltage applied to the control means such as microprocessor with high accuracy.

A discharge lamp lighting device in accordance with the present invention is characterized by including: a power conversion section that boosts voltage supplied from power supply to apply the boosted voltage to a discharge lamp; storage means that stores a voltage correction value to show a relationship between voltage previously applied to the discharge lamp and voltage developed by the power conversion section; and control means that controls the power conversion section according to a correction voltage obtained by correcting voltage developed by the power conversion section by the voltage correction value.

With this arrangement, the discharge lamp lighting device in accordance with the present invention stores a voltage correction value to show a relationship between voltage previously applied to the discharge lamp and voltage developed by the power conversion section and controls the power conversion section according to the correction voltage obtained by correcting voltage developed by the power conversion section by the voltage correction value, so that the discharge lamp lighting device can control power supplied to the discharge lamp with high accuracy.

### BRIEF DESCRIPTION OF THE DRAWINGS

FIG. 1 is a block diagram to show one example of a discharge lamp lighting device in accordance with embodiment 1 of the present invention.

FIG. 2 is a graph to show one example of control of a DC/AC conversion section in the discharge lamp lighting device shown in FIG. 1.

FIG. 3 is a graph to show one example of relationship between power supplied to a discharge lamp and a battery voltage in the discharge lamp lighting device shown in FIG. 1.

FIG. 4 is a block diagram to show one example of a discharge lamp lighting device in accordance with embodiment 2 of the present invention.

FIG. 5 is a graph to show one example of control of a DC/AC conversion section in the discharge lamp lighting device shown in FIG. 4.

### BEST MODE FOR CARRING OUT THE INVENTION

Hereafter, to describe the present invention more specifically, a best mode for carrying out the present invention will be described with reference to the attached drawings.

### Embodiment 1

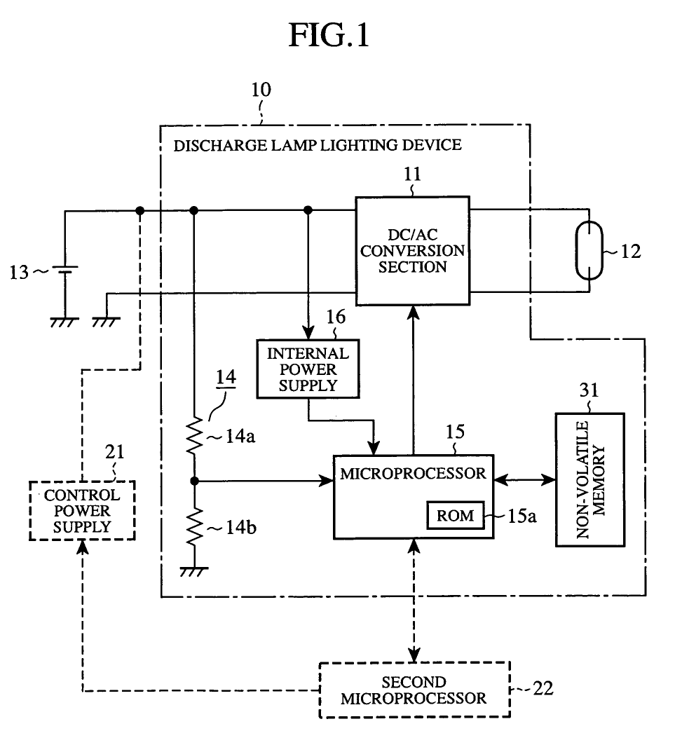

FIG. 1 is a block diagram to show one example of a discharge lamp lighting device in accordance with embodiment 1 of the present invention. The discharge lamp lighting device in accordance with embodiment 1 of the present invention shown in the drawing is used, for example, for a vehicle. The discharge lamp lighting device 10 shown in the drawing includes a DC/AC conversion section (power conversion section) 11 and although not shown in FIG. 1, the DC/AC conversion section 11 has a DC/DC converter and a DC/AC inverter. A discharge lamp (for example, head lamp) 12 is connected to the output side of DC/AC conversion section 11 and a DC power supply (for example, vehicle mounted battery) 13 is connected to the input side of DC/AC conversion section 11. Here, in a vehicle, an alternator (not shown) is connected to the vehicle mounted battery 13 and when an engine is driven, the vehicle mounted battery 13 is charged by the alternator.

The vehicle mounted battery 13 is connected to a microprocessor (control means) 15 via an I/F circuit (voltage dividing means) 14 including voltage dividing resistors 14a and 14b and the microprocessor 15 monitors the voltage of vehicle mounted battery (hereinafter simply referred to as “battery voltage”) according to a divided voltage input from the I/F circuit 14, as will be described later. On the other hand, a reference voltage applied to the microprocessor 15 is applied by an internal power supply 16 produced by the vehicle mounted battery 13 and the microprocessor 15 is operated by the internal power supply 16.

When it is now assumed that a battery voltage varies within a range from 0 V to 20 V and that the resistances of the voltage dividing resistors 14a and 14b are 30 kΩ and 10 kΩ, respectively, the battery voltage is multiplied by ¼ by the I/F circuit 14 and is applied to the microprocessor 15. In other words, the battery voltage is converted to 0 V to 5 V by the I/F circuit 14 and is applied to the microprocessor 15. However, the resistances have unavoidable errors and the errors are different from one resistor to another in many cases.

In reality a resistor has generally an error of approximately ±1%, and hence when two resistors 14a and 14b are used respectively, they have a total error of approximately ±2%. This means that, for example, when a battery voltage is 10 V, voltage applied to the microprocessor 15 by the I/F circuit becomes 2.5 V ±0.05 V.

On the other hand, the microprocessor 15 evaluates the value of divided voltage with respect to a predetermined reference voltage (for example, 5 V) and for example, when the reference voltage is 5 V and the divided voltage is 2.5 V, it becomes that the microprocessor 15 evaluates that the divided voltage is 0.5 times the reference voltage. In general, a reference voltage produced by an internal power supply has an error and the error of this reference voltage is approximately 2%. In other words, the reference voltage ranges from 4.9 V to 5.1 V.

If it is now assumed that the reference voltage in the microprocessor 15 is 5.1 V and that an input voltage of 2.5 V is applied at this time to the microprocessor 15, it becomes that the microprocessor 15 evaluates that the input voltage is 0.49 times the reference voltage. However, the microprocessor 15 itself can not recognize the error of reference voltage (that is, because the reference voltage is defined to be set at 5 V in the microprocessor 15) and hence the microprocessor actually recognizes that input voltage=5 V×0.49=2.45 V. If it is assumed that the reference voltage ranges from 4.9 V to 5.1 V, when the actual input voltage is 2.5 V, the microprocessor 15 recognizes that the input voltage ranges from 2.45 V to 2.55 V.

As a result, when the battery voltage is 10V, as described above, the microprocessor 15 has a voltage of 2.5 V ±0.05 V (10 V ±0.2 V, when converted to a battery voltage) applied thereto because the voltage dividing resistors 14a and 14b have the errors and hence the microprocessor 15 recognizes the battery voltage within a range from 9.6 V to 10.4 V. Therefore, the battery voltage detected by the microprocessor 15 differs from one discharge lamp lighting device to another. In short, the accuracy of detection differs from one discharge lamp lighting device to another.

To prevent such a malfunction, as shown by the broken lines in FIG. 1, a control power supply (constant voltage power supply) 21 is connected to the DC/AC conversion section 11 and a second microprocessor 22 is connected to the microprocessor 15 and the control power supply 21 to apply a control voltage to the DC/AC conversion section 11 from the control power supply 21 and to apply a control voltage to the microprocessor 15 via the I/F circuit 14. In this regard, in the example shown in FIG. 1, a non-volatile memory (storage means) 31 is connected to the microprocessor 15.

When the control voltage is applied from the control power supply 21, a storage command is sent from the second microprocessor 22 to bring the microprocessor 15 to a threshold voltage storing mode and the control voltage is output from the control power supply 21. When the threshold voltage is set, for example, a voltage of 5.5 V is output as the control voltage from the control power supply 21.

This control voltage is divided by the I/F circuit 14 and is applied to the microprocessor 15 and in the threshold voltage storing mode, the microprocessor 15 stores this divided voltage as a threshold voltage in the non-volatile memory 31. As a result, this threshold voltage reflects variations in the resistors 14a and 14b in the I/F circuit 14 and further reflects variations in the reference voltage of microprocessor 15.

Further, the microprocessor 15 finds the ratio between the control voltage and the threshold voltage (control voltage/threshold voltage) as a correction value (correction coefficient) and stores this correction value in the non-volatile memory 31. Then, the microprocessor 15, as will be described later, controls the DC/AC conversion section 11 according to the threshold voltage and the correction value to control the discharge lamp 12.

Next, operation will be described.

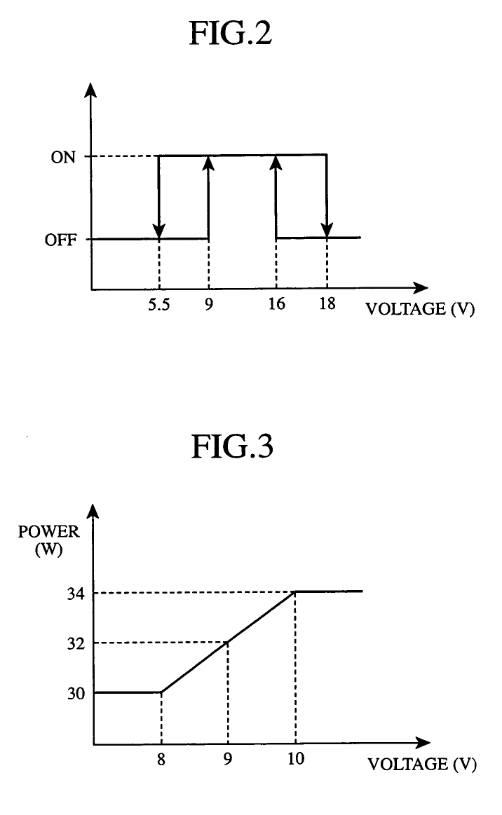

Referring to FIG. 1 and FIG. 2, as described above, the threshold voltage and the correction value are stored in the non-volatile memory 31 and then the discharge lamp lighting device 10 is connected to the vehicle mounted battery 13 and is connected to the discharge lamp 12.

Now, it is assumed that, as shown in FIG. 2, when a battery voltage becomes 9 V, the microprocessor 15 turns on the DC/AC conversion section 11 to light the discharge lamp 12 and that when the battery voltage becomes 18 V after the discharge lamp 12 is lit, the microprocessor 15 turns off the DC/AC conversion section 11 to extinguish the discharge lamp 12. Further, it is assumed that when the battery voltage becomes 9V, the discharge lamp 12 is lit and that when the battery voltage becomes 5.5 V after the discharge lamp 12 is lit, the microprocessor 15 turns off the DC/AC conversion section 11 to extinguish the discharge lamp 12. Similarly, it is assumed that when the battery voltage becomes 18 V, the discharge lamp 12 is extinguished and that when the battery voltage becomes 16 V, the microprocessor 15 turns on the DC/AC conversion section 11 to light the discharge lamp 12.

The microprocessor 15 is made to control the DC/AC conversion section 11 on the basis of the battery voltage, that is, the divided voltage applied by the I/F circuit 14 and when a main switch (not shown) is switched on, the microprocessor 15 finds a correction divided voltage from the correction value stored in the non-volatile memory 31 and the divided voltage.

When this correction divided voltage is higher than a divided voltage obtained by dividing the battery voltage (the voltage dividing ratio of I/F circuit 14 is previously set in the microprocessor 15), that is, this correction divided voltage is higher than 2.25V (here, it is assumed that the voltage dividing resistors 14a and 14b have resistances of 30 kΩ and 10 kΩ, respectively), the microprocessor 15 controls the DC/AC conversion section 11 to light the discharge lamp 12.

The correction divided voltage reflects variations in the resistances of resistors 14a and 14b in the I/F circuit 14 and variations in the reference voltage of microprocessor 15 and hence when the battery voltage becomes 9 V, the DC/AC conversion section 11 is turned on and the discharge lamp 12 is lit.

Similarly, when the correction divided voltage becomes 4.5 V (when the battery voltage becomes 18 V), the microprocessor 15 turns off the DC/AC conversion section 11, and when the correction divided voltage becomes 4 V (when the battery voltage becomes 16V), the microprocessor 15 turns on the DC/AC conversion section 11.

On the other hand, the microprocessor 15 turns on the DC/AC conversion 11 and then compares the divided voltage with the threshold voltage and, when the divided voltage becomes the threshold voltage read from the non-volatile memory 31 (that is, when the divided voltage becomes 1.375 V), turns off the DC/AC conversion section 11. This threshold voltage, as described above, reflects variations in the resistances of resistors 14a and 14b in the I/F circuit 14 and variations in the reference voltage of microprocessor 15 and hence when the battery voltage becomes 5.5 V, the microprocessor 15 can turn off the DC/AC conversion section 11 with accuracy.

Here, referring to FIG. 3, it is assumed that power from a maximum power of 34 W to a minimum power of 30 W is supplied to the discharge lamp 12 where voltage input to the lamp lighting device varies from 8 V to 10 V and power linearly varies from 30 W to 34 W. Then, it is assumed that even if the voltage input to the lamp lighting device becomes higher than 10 V, the power is kept at 34 W. In other words, current passing through the discharge lamp 12 is controlled by the DC/AC conversion section 11 according to an increase in the voltage.

On the other hand, even if the voltage input to the lamp lighting device becomes lower than 8 V, the power is kept at 30 W and the DC/AC conversion section 11 increases current input to the lamp lighting device. However, when the current passing through the discharge lamp 12 increases, heat may cause damage to the discharge lamp 12. Hence, as described above, when the battery voltage becomes 5.5 V, the DC/AC conversion section 11 is turned off. At this time, it is necessary to turn off the DC/AC conversion section 11 with high accuracy in consideration of the operating voltage of microprocessor 15 and hence the DC/AC conversion section 11 is turned off by the use of threshold voltage.

Here, in the above embodiment, an example has been described in which the microprocessor 15 stores the threshold voltage and the correction value in the non-volatile memory 31. However, it is also recommended that the microprocessor 15 stores the threshold voltages in the non-volatile memory 31 in correspondence with the battery voltages of 5.5 V, 9 V, 16 V, and 18 V for controlling the DC/AC conversion section 11 and compares these threshold voltages with the divided voltage to control the DC/AC conversion section 11.

As described above, according to this embodiment 1, the microprocessor 15 stores the divided voltage obtained by applying a predetermined voltage to the I/F circuit 14 from the control power supply as the threshold voltage in the non-volatile memory 31 and compares this threshold voltage with the divided voltage obtained by dividing the battery voltage by the I/F circuit 14 to control the DC/AC conversion section 11. Hence, the microprocessor 15 can detect the battery voltage with high accuracy and control the discharge lamp with high accuracy.

At this time, it is also recommendable to adopt a structure in which the microprocessor 15 corrects the divided voltage obtained by dividing the battery voltage by using a correction value in place of the threshold voltage to obtain a correction voltage and controls the DC/AC conversion section 11 according to this correction voltage. Further, if the microprocessor 15 controls the DC/AC conversion section 11 by the threshold voltage when the battery voltage is lower than a predetermined voltage and controls the DC/AC conversion section 11 according to the correction voltage obtained according to the correction value when the battery voltage is higher than the predetermined voltage, the microprocessor 15 can light or extinguish the discharge lamp with high accuracy in consideration of the operating voltage applied to the microprocessor 15.

### Embodiment 2

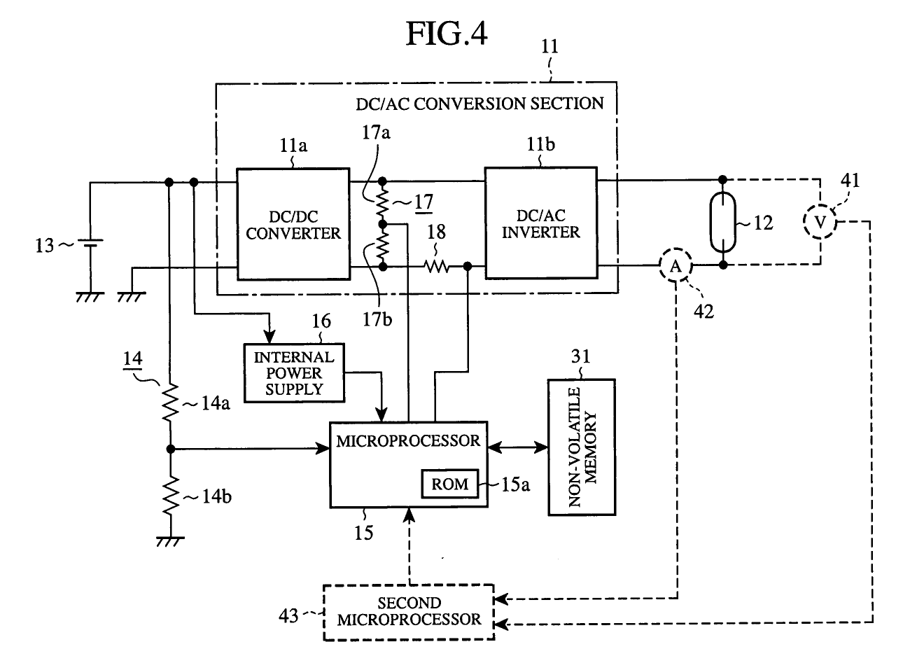

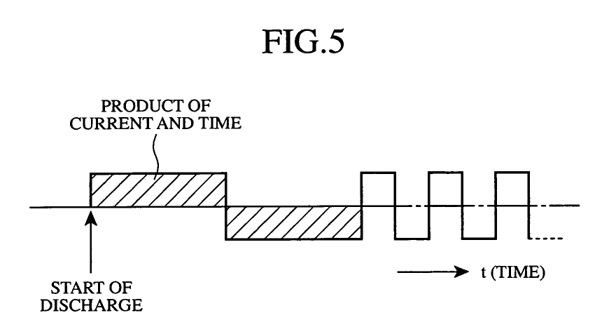

FIG. 4 is a block diagram to show one example of a discharge lamp lighting device in accordance with embodiment 2 of the present invention. The same constituent elements shown in FIG. 4 as the discharge lamp lighting device shown in FIG. 1 are denoted by the same reference symbols. In FIG. 4, the DC/AC conversion section 11 has a DC/DC converter 11a and a DC/AC inverter 11b and the DC/DC converter 11a is connected to the vehicle mounted battery 13 and the DC/AC inverter 11b is connected to the discharge lamp 12.

Further, voltage applied to the discharge lamp 12 (hereinafter referred to as “discharge lamp application voltage”) is divided by an I/F circuit 17 including voltage dividing resistors 17a and 17b and is applied to the microprocessor 15 and current passing through the discharge lamp 12 is converted to voltage by a resistor 18 (hereinafter referred to as “discharge lamp conversion voltage), thereby being applied to the microprocessor 15.

As described in embodiment 1, a threshold voltage and a correction value corresponding to a battery voltage are stored in the non-volatile memory 31 (in this embodiment 2, these threshold voltage and correction value are hereinafter referred to as “battery threshold voltage” and “battery correction value”, respectively).

By the way, even if the battery voltage varies, power supplied to the discharge lamp 12 is kept within a predetermined range (for example, 30 W to 34 W), as described above. However, when the battery voltage varies, naturally, the voltage and/or current applied to the discharge lamp 12 vary. Hence, to keep the power supplied to the discharge lamp 12 within a predetermined range, it is necessary to detect the output power of DC/DC converter 11a and to know the relationship between the power actually supplied to the discharge lamp 12 and this detected power.

However, since the voltage dividing resistors 17a and 17b and the resistor 18 have variations in manufacture, voltage and current on the output side of DC/DC converter 11a and voltage and current input to the microprocessor 15 vary from one discharge lamp lighting device to another. On this account, as shown by the broken lines in FIG. 4, a voltmeter 41 and an ammeter 42 are beforehand connected to the discharge lamp 12 to measure voltage applied to the discharge lamp 12 and current passing through the discharge lamp 12. Then, its measurement results (measured voltage and measured current) are supplied to a second microprocessor 43.

When a storage command is sent to the microprocessor 15 from the second microprocessor 43, the microprocessor 15 obtains the voltage from the I/F circuit 17 and the current from the resistor 18 as a reference voltage and a reference current in correspondence with the measured voltage and the measured current, finds correction values for correcting the reference voltage and the reference current to the measured voltage and the measured current as a conversion voltage correction value and a conversion current correction value, and stores these conversion voltage correction value and conversion current correction value in the non-volatile memory 31. The microprocessor 15 controls the DC/DC converter 11a in the manner described later according to these conversion voltage correction value and conversion current correction value.

Next, operation will be described.

Referring to FIG. 4, as described above, the reference voltage and the reference current are stored in the non-volatile memory 31 and then the voltmeter 41, the ammeter 42, and the second microprocessor 43 are dismounted. Now, it is assumed that a power of 34 W is supplied to the discharge lamp 12 from the DC/AC inverter 11b, whereby a voltage of 85 V is applied to the discharge lamp 12 and a current of 0.4 A is passed through the discharge lamp 12.

On the other hand, the microprocessor 15 monitors voltage from the I/F circuit 17 (hereinafter referred to as “output voltage”) and current obtained from the resistor 18 (hereinafter referred to as “output current”) and at this time, the microprocessor 15 corrects the output voltage and the output current according to the conversion voltage correction value and the conversion current correction value stored in the non-volatile memory 31 to make a correction voltage and a correction current.

Then, the microprocessor 15 knows power obtained from the correction voltage and correction current (power supplied to the discharge lamp 12) and controls the DC/DC converter 11a to adjust the power supplied to the discharge lamp 12 to, for example, 34 W. For example, when the correction voltage is 85 V and the correction current is out of 0.4 A, the microprocessor 15 controls the DC/DC converter 11a so as to bring the output current of DC/DC converter 11a to become 0.4 A.

If the conversion voltage correction value and the conversion current correction value are stored and the output voltage and the output current are corrected in this manner, it is possible to remove errors caused by the manufacture variations of I/F circuit 17 and resistor 18 and hence to control the power to be supplied to the discharge lamp 12 with high accuracy.

While the conversion voltage correction value and the conversion current correction value are stored in the non-volatile memory 31 in the above embodiment, it is also recommended that only the conversion voltage correction value be stored in the non-volatile memory 31 and that the output current of DC/DC converter 11a be adjusted according to power to be applied to the discharge lamp 12.

By the way, since AC power is supplied to the discharge lamp 12, as shown in FIG. 5, the electrode of discharge lamp 12 is not warmed up in the early stages of start of discharge and hence when current changes from a plus value to a minus value or from a minus value to a plus value, a faulty discharge may unavoidably occur. For this reason, in the early stages of start of discharge, the period of AC current (rectangular wave) is elongated to warm up the electrode of discharge lamp 12 sufficiently and then the period of rectangular wave is made a short constant period. In other words, in the early stages of start of discharge, the product of current and time is made large to warmup the electrode of discharge lamp 12 sufficiently.

Also in this case, the output current is corrected by the conversion current correction value and the current passing through the discharge lamp 12 is grasped with high accuracy to control the output current of DC/DC converter 11a.

As described above, according to this embodiment 2, a voltage correction value to show the relationship between voltage to be previously applied to the discharge lamp 12 and voltage from the I/F circuit 17 is stored and the DC/AC conversion section 11 is controlled according to a correction voltage obtained by correcting voltage developed by the DC/AC conversion section 11 by the voltage correction value, so that it is possible to control power to be supplied to the discharge lamp 12 with high accuracy.

### INDUSTRIAL APPLICABILITY

As described above, a discharge lamp lighting device in accordance with the present invention is suitable for lighting and controlling a discharge lamp such as headlamps of a vehicle with high accuracy.

1. A discharge lamp lighting device comprising:
a power conversion section that boosts voltage supplied from power supply to apply the boosted voltage to a discharge lamp;
voltage dividing means that divides a power supply voltage to make a divided voltage;
storage means that stores a divided voltage, which is obtained by applying a predetermined voltage to the voltage dividing means, as a threshold voltage; and
control means that compares the threshold voltage with the divided voltage obtained by dividing the power supply voltage by the voltage dividing means to control the power conversion section.

2. The discharge lamp lighting device as claimed in claim 1, wherein the control means stores the threshold voltage in the storage means according to a storage command given from an external device.

3. A discharge lamp lighting device comprising:
a power conversion section that boosts voltage supplied from power supply to apply the boosted voltage to a discharge lamp;
voltage dividing means that divides a power supply voltage to make a divided voltage;
storage means that stores a correction value responsive to a divided voltage, which is obtained by applying a predetermined voltage to the voltage dividing means, and the predetermined voltage; and
control means that controls the power conversion section according to a correction voltage obtained by correcting a divided voltage obtained by dividing the power supply voltage according to the correction value.

4. The discharge lamp lighting device as claimed in claim 3, wherein the control means finds a correction value according to a storage command given from the an external device and stores the correction value in the storage means.

5. The discharge lamp lighting device as claimed in claim 1 wherein the storage means makes the divided voltage, which is obtained by applying a predetermined voltage to the voltage dividing means, the threshold voltage and stores a correction value responsive to a divided voltage, which is obtained by applying a predetermined voltage to the voltage dividing means, and the predetermined voltage, and wherein when the power supply voltage is within a first voltage range, the control means compares the threshold voltage with the divided voltage to control the power conversion section and when the power supply voltage is within a second voltage range, the control means controls the power conversion section according to a correction voltage obtained by correcting a divided voltage obtained by dividing the power supply voltage according to the correction value.

6. A discharge lamp lighting device as claimed in claim 3, wherein
the storage means makes the divided voltage which is obtained by applying a predetermined voltage to the voltage dividing means, the threshold voltage and stores a correction value responsive to a divided voltage, which is obtained by applying a predetermined voltage to the voltage dividing means, and the predetermined voltage, and wherein
when the power supply voltage is within the first voltage range, the control means compares the threshold voltage with the divided voltage to control the power conversion section and when the power supply voltage is within a second voltage range, the control means controls the power conversion section according to a correction voltage obtained by correcting a divided voltage obtained by dividing the power supply voltage according to the correction value.

7. A discharge lamp lighting device comprising:
a power conversion section that boosts voltage supplied from power supply to apply the boosted voltage to a discharge lamp;
storage means that stores a current correction value to show a relationship between current applied to the discharge lamp or current developed by the power conversion section and current obtained therefrom; and
control means that controls the power conversion section according to a correction current obtained by correcting current applied to the discharge lamp or current developed by the power conversion section by the current correction value.
